(19) United States
(12) Patent Application Publication
(10) Pub. No.: US 2023/0261901 A1
(43) Pub. Date: Aug. 17, 2023

(54) GATEWAY DEVICE, RELAY SYSTEM, RELAY METHOD AND RELAY PROGRAM

(71) Applicant: Nippon Telegraph and Telephone Corporation, Tokyo (JP)

(72) Inventor: Mai URABE, Musashino-shi, Tokyo (JP)

(21) Appl. No.: 18/014,364

(22) PCT Filed: Jul. 6, 2020
(86) PCT No.: PCT/JP2020/026422

§ 371 Date: Jan. 4, 2023

(51) Int. Cl. H04L 12/66; H04L 65/1104

(52) U.S. Cl. CPC H04L 12/66; H04L 65/1104

(57) ABSTRACT

A gateway device that connects a PSTN network to an IP network includes a signal conversion unit that extracts information necessary for ISUP service provision from information included in a received ISUP signal, and generates an SIP signal in which the information is set in the header, a determination unit that determines whether to relay the header for a connection destination device on the basis of a type of a connection destination device and terminal conditions of an outgoing terminal and an incoming terminal that are set in the ISUP signal, and a relay unit that relays the SIP signal to a connection destination device in a case of relaying the header, and transmits an SIP signal from which the header has been deleted to a connection destination device in a case of not relaying the header.

### TECHNICAL FIELD

The present invention relates to a gateway device, a relay system, a relay method, and a relay program.

### BACKGROUND ART

In a network such as a telephone network in which a transmission destination and a transmission source are assumed to be a trusted session initiation protocol (SIP) node group, there is an SIP-I as technology of distributing an integrated services digital network user part (ISUP) to an SIP (Non Patent Literature 1).

### CITATION LIST

### Non Patent Literature

Non Patent Literature 1: ITU-T Q.1912.5 Annex C, “Interworking between session initiation protocol (SIP) and bearer independent call control protocol or ISDN user part”, [online], Internet <URL:https://www.itu.int/rec/T-REC-Q.1912.5-201801-I/en>

### SUMMARY OF INVENTION

### Technical Problem

In a case where the SIP-I is applied to an existing network, there are following issues. Although an ISUP signal includes information unnecessary for ISUP service provision, the entire ISUP signal is encapsulated and distributed in the SIP-I. For this reason, a part of a signal necessary for the ISUP service provision cannot partially be distributed.

Furthermore, since the ISUP signal encapsulated by the SIP-I is distributed even to a section (range) in which the ISUP signal is unnecessary, decoding processing of the encapsulated ISUP signal is necessary even in the section in which the ISUP signal is unnecessary, and thus performance is deteriorated.

The present invention has been made in view of the above circumstances, and an object of the present invention is to provide a gateway device, a relay system, a relay method, and a relay program for distributing information necessary for the ISUP service provision to a section in which an ISUP signal is necessary.

### Solution to Problem

In order to achieve the above object, one aspect of the present invention is a gateway device that connects a PSTN network to an IP network includes a signal conversion unit that extracts information necessary for ISUP service provision from information included in a received ISUP signal, and generates an SIP signal in which the information is set in the header, a determination unit that determines whether to relay the header for a connection destination device on the basis of a type of a connection destination device and terminal conditions of an outgoing terminal and an incoming terminal that are set in the ISUP signal, and a relay unit that relays the SIP signal to a connection destination device in a case of relaying the header, and transmits an SIP signal from which the header has been deleted to a connection destination device in a case of not relaying the header.

The one aspect of the present invention is a relay system including the above-described gateway device and another gateway device that connects a host IP network to other IP networks, in which the another gateway device includes a determination unit that determines whether to relay the header of the SIP signal for respective connection destination devices of the another gateway device and a relay unit that relays the SIP signal to the respective connection destination devices in a case of relaying the header, and transmits an SIP signal from which the header has been deleted to the respective connection destination devices in a case of not relaying the header.

The one aspect of the present invention is a relay method performed by a gateway device that connects a public switched telephone network (PSTN) network to an Internet protocol (IP) network, in which the relay method includes a signal conversion step of extracting information necessary for ISUP service provision from information included in a received ISUP signal, and generating an SIP signal in which the information is set in the header, a determination unit that determines whether to relay the header for a connection destination device on the basis of a type of a connection destination device and terminal conditions of an outgoing terminal and an incoming terminal that are set in the ISUP signal, and a relay step of relaying the SIP signal to a connection destination device in a case of relaying the header, and transmitting an SIP signal from which the header has been deleted to a connection destination device in a case of not relaying the header.

The one aspect of the present invention is a relay program for causing a computer to function as the above-described gateway device.

### Advantageous Effects of Invention

According to the present invention, a gateway device, a relay system, a relay method, and a relay program for distributing information necessary for ISUP service provision to a section in which an ISUP signal is necessary can be provided.

### BRIEF DESCRIPTION OF DRAWINGS

FIG. 1 is a network configuration diagram of a first embodiment.

FIG. 2 is a configuration diagram illustrating a configuration of a GW (gateway) device that connects a PSTN network to an IP network.

FIG. 3 is a configuration diagram illustrating a configuration of a GW device that connects the host IP network to other IP networks.

FIG. 4 is an explanatory diagram used for describing operation of the first embodiment.

FIG. 5 is a network configuration diagram of a second embodiment.

FIG. 6 is an explanatory diagram used for describing operation of the second embodiment.

FIG. 7 is a hardware configuration example.

### DESCRIPTION OF EMBODIMENTS

Hereinafter, embodiments of the present invention will be described with reference to the drawings.

### First Embodiment

### Network Configuration

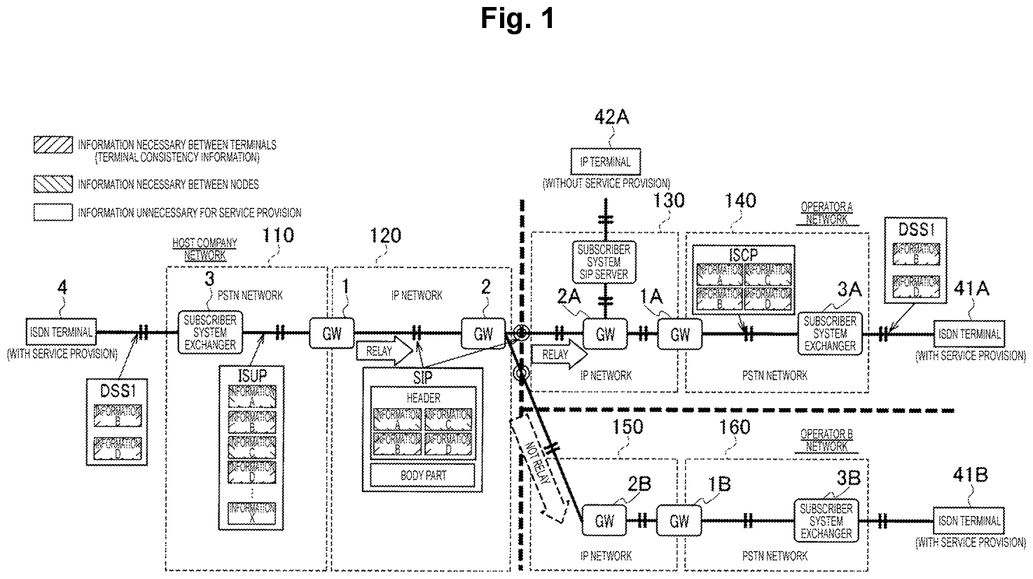

FIG. 1 illustrates a configuration example of networks (networks) of a first embodiment. An example illustrated in FIG. 1 has a network configuration in which a host company network is connected to other company networks. The host company network includes a PSTN network 110 and an IP network 120. In the PSTN network 110, a subscriber system exchanger 3 is disposed. Between the PSTN network 110 and the IP network 120, a gateway device 1 (hereinafter, “GW device”) is disposed. In the IP network 120, a GW device 2 (another GW device) is disposed.

The subscriber system exchanger 3 accommodates an integrated services digital network (ISDN) terminal 4 (telephone). The illustrated ISDN terminal 4 is a terminal to which the subscriber system exchanger 3 provides an ISUP service. When the ISDN terminal 4 makes a call, terminal consistency information (information B and information D in FIG. 1) in a digital subscriber signalling system No. 1 (DSS 1) is transmitted to the subscriber system exchanger 3. This information is information necessary for the ISUP service provision, and is information necessary between terminals.

Upon receiving the terminal consistency information by the call of the ISDN terminal 4, the subscriber system exchanger 3 generates an ISUP signal and transmits the ISUP signal to the GW device 1. The ISUP signal (ISUP information) is a message transmitted and received between subscriber system exchangers. The ISUP signal includes terminal consistency information, node information that is necessary for the ISUP service provision and is necessary between nodes (information A and information C in FIG. 1), and information that is unnecessary for the ISUP service provision (information X in FIG. 1). The node information is information necessary between nodes for toll adjustment, transmission of guidance, and the like.

The GW device 1 relays (interworks, distributes) the ISUP signal received from the subscriber system exchanger 3 to the IP network (IP section). The GW device 1 of the present embodiment converts the ISUP signal into an SIP signal. Specifically, the GW device 1 extracts the terminal consistency information and the node information necessary for the ISUP service provision from the ISUP signal, and generates an SIP signal in which the extracted information is set in the header. As a result, in the present embodiment, only information necessary for the ISUP service provision can be distributed to the IP section. Note that the ISUP information set in the header can be appropriately set by a user according to service provision status.

Furthermore, the GW device 1 controls a section to which the header of the SIP signal is relayed. Specifically, the GW device 1 determines whether to relay the header of the SIP signal on the basis of a type of a connection destination device and terminal conditions of an outgoing terminal and an incoming terminal. In a case of relaying the header, the GW device 1 relays the SIP signal as it is to the connection destination device, and in a case of not relaying the header, the GW device 1 transmits the SIP signal from which the header has been deleted to the connection destination device.

In FIG. 1, the connection destination device of the GW device 1 is the GW device 2, and is a type of device to which the header is relayed. Furthermore, it is assumed that the destination of the ISDN terminal 4 (outgoing terminal) is an ISDN terminal 41A (incoming terminal) to which the ISUP service is provided. In this case, the GW device 1 determines to relay the header to the GW device 2, and relays the generated SIP signal to the GW device 2 transparently (as it is).

Upon receiving the SIP signal to which the header is added, the GW device 2 determines whether to distribute the header of the SIP signal for respective connection destination devices (GW devices 2A and 2B) of other company networks 130 and 150. For example, in a case where the incoming terminal of the SIP signal is the ISDN terminal 41A of an operator A network, the GW device 2A transparently relays the SIP signal to which the header is added to a GW device 1A. On the other hand, in a case where the incoming terminal of the SIP signal is an ISDN terminal 41B of an operator B network (without the ISUP service provision), the GW device 2 relays the SIP signal from which the header has been deleted to a GW device 2B. As a result, in the present embodiment, the ISUP signal can be distributed only to a section in which the ISUP signal is necessary.

### Configuration of GW Devices

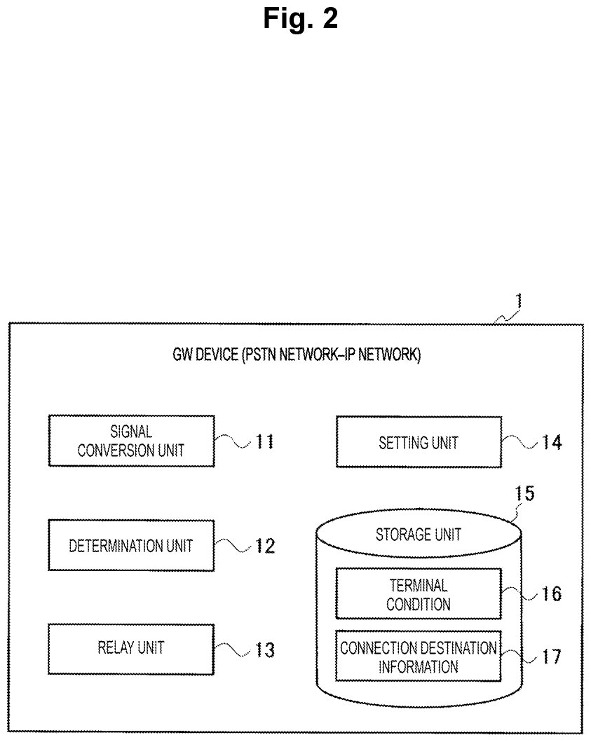

FIG. 2 is a functional block diagram illustrating functions of the GW device 1 that connects the PSTN network to the IP network in FIG. 1. Note that the GW devices 1A and 1B are similar to the GW device 1. The illustrated GW device 1 includes a signal conversion unit 11, a determination unit 12, a relay unit 13, a setting unit 14, and a storage unit 15.

The signal conversion unit 11 converts an ISUP signal into an SIP signal or an SIP signal into an ISUP signal. Specifically, upon receiving an ISUP signal from the subscriber system exchanger 3, the signal conversion unit 11 extracts information necessary for the ISUP service provision from information included in the received ISUP signal, and generates an SIP signal in which the extracted information is set in the header. The information necessary for the ISUP service provision is the above-described terminal consistency information and node information. Furthermore, upon receiving an SIP signal in which ISUP information is set in the header from the GW device 2, the signal conversion unit 11 generates an ISUP signal including the ISUP information in the header. Note that ISUP information set in the header by the signal conversion unit 11 can be appropriately set by a user via the setting unit 14 according to service provision status.

The determination unit 12 determines whether to relay the header of the SIP signal for the connection destination device of the GW device 1 on the basis of a type of the connection destination device and the terminal conditions of the outgoing terminal and the incoming terminal that are set in the ISUP signal. Specifically, the determination unit 12 makes determination with reference to the storage unit 15.

The storage unit 15 stores a terminal condition 16 and connection destination information 17. The terminal condition 16 includes a terminal type, a bearer condition, and necessity of header relay. The terminal type indicates a type of a terminal such as an analog terminal, an ISDN terminal, or an IP terminal. The bearer type indicates a type of a bearer such as voice or non-restriction. In the terminal condition 16, whether to relay the ISUP header is set for respective terminal types and bearer types. For example, in the terminal condition 16, in a case where the type of the terminal is an “ISDN terminal” and the type of the bearer is “non-restriction”, “relay” is set as the necessity of header relay.

As the connection destination information 17, information related to the connection destination device connected to said GW device 1 in the IP network (server, GW device, or the like) is set. Specifically, the connection destination information 17 includes information for specifying said connection destination device (IP address, port number, domain name, and the like), the device type, the necessity of header relay, and the like for the connection destination device. The device type is, for example, a GW device, a subscriber system SIP server accommodating the IP terminal, an application server, or the like.

The necessity of header relay may be automatically set according to the device type, or may be set by a user such as a maintenance person. For example, in a GW device, “relay” is set as the necessity of header relay. In a case where the device type is the subscriber system SIP server or the application server, since the ISDN terminal to which the ISUP service is provided is not connected, “not relay” is set as the necessity of header relay.

The determination unit 12 acquires the terminal conditions of the outgoing terminal and the incoming terminal from the header of the ISUP signal or the SIP signal, and acquires the necessity of header relay corresponding to said terminal conditions from the terminal condition 16. Furthermore, the determination unit 12 refers to the connection destination information 17 and acquires the necessity of header relay for the connection destination device. In the present embodiment, the determination unit 12 determines to relay the header of the SIP signal only in a case where the necessity of header relay of the terminal conditions is “relay” and the necessity of header relay of the connection destination device is “relay”, and determines not to relay the header of the SIP signal otherwise.

In a case of relaying the header, the relay unit 13 relays the SIP signal to the connection destination device, and in a case of not relaying the header, the relay unit 13 deletes the header from the SIP signal and transmits the SIP signal after the deletion to the connection destination device.

The setting unit 14 is a user interface by which a user sets the terminal condition 16 and the connection destination information 17 in the storage unit 15. The setting unit 14 sets the terminal condition 16, the necessity of header relay in the connection destination information 17, the ISUP information set in the header, and the like on the basis of information input by a user.

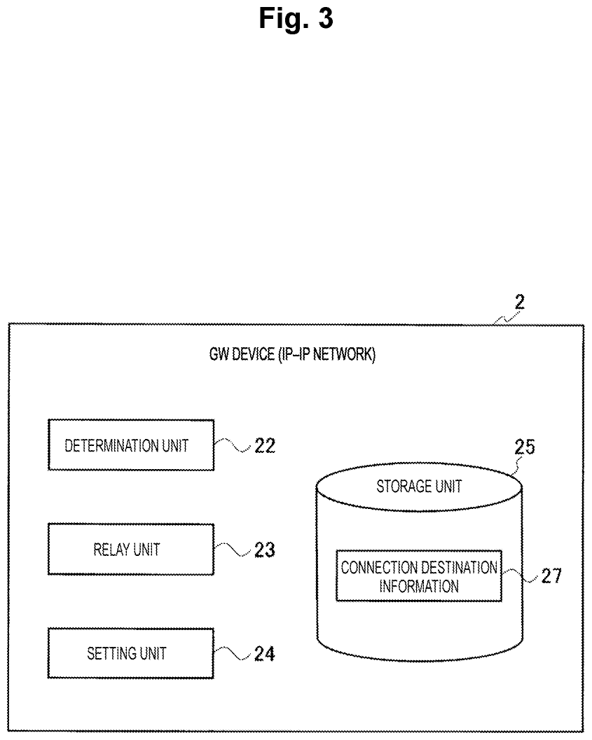

FIG. 3 is a functional block diagram illustrating functions of the GW device 2 (another GW device) that connects the host IP network 120 to the other IP networks 130 and 150 in FIG. 1. Note that the GW devices 2A and 2B are similar to the GW device 2. The illustrated GW device 2 includes a determination unit 22, a relay unit 23, a setting unit 24, and a storage unit 25.

The determination unit 22 determines whether to relay the header of the SIP signal on the basis of a type of a connection destination device for respective connection destination devices connected to said GW device 2. The connection destination devices include the GW devices 2A and 2B of the other IP networks 130 and 150. Specifically, the determination unit 22 makes determination with reference to the storage unit 25. The storage unit 25 stores connection destination information 27.

As the connection destination information 27, information related to the connection destination devices (server, GW device, or the like) of the host company network and the other company networks connected to said GW device 2 is set. Specifically, the connection destination information 27 includes information for specifying a connection destination device (IP address, port number, domain name, and the like), the device type, the necessity of header relay, and the like for said respective connection destination devices. The device type is, for example, a GW device, a subscriber system SIP server accommodating the IP terminal, an application server, or the like.

The necessity of header relay may be automatically set according to the device type, or may be set by a user such as a maintenance person. For example, in a GW device, “relay” is set as the necessity of header relay. In a case where the device type is the subscriber system SIP server or the application server, since the ISDN terminal to which the ISUP service is provided is not connected, “not relay” is set as the necessity of header relay.

In a case of relaying the header, the relay unit 23 relays the SIP signal to the connection destination devices, and in a case of not relaying the header, the relay unit 23 deletes the header from the SIP signal and transmits the SIP signal after the deletion to the connection destination devices.

The setting unit 24 is a user interface by which a user sets the connection destination information 27 in the storage unit 25. The setting unit 24 sets the necessity of header relay in the connection destination information 27 and the like on the basis of information input by a user.

### Operation of Relay System

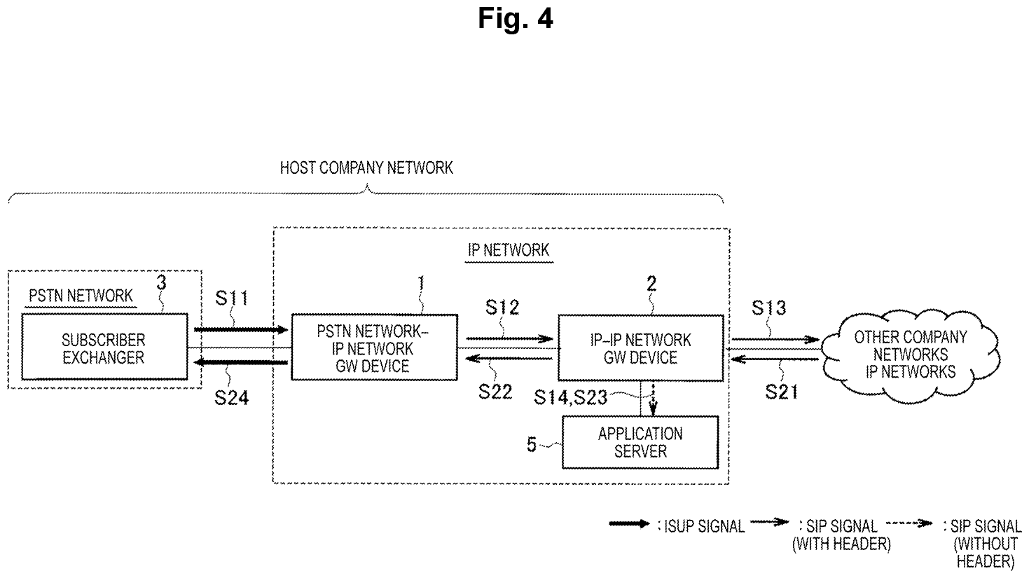

FIG. 4 is a diagram schematically illustrating operation of the GW device 1 and the GW device 2 (relay system) of the present embodiment.

Upon receiving a DSS1 including terminal consistency information from the accommodated ISDN terminal 4, the subscriber system exchanger 3 generates an ISUP signal and transmits the ISUP signal to the GW device 1 (S11).

The GW device 1 converts the ISUP signal into an SIP signal in order to relay the ISUP signal in the IP network. Specifically, the GW device 1 extracts information necessary for the ISUP service provision from information included in the ISUP signal, and generates an SIP signal in which the extracted information is set in the header. The GW device 1 determines whether to relay the header of the SIP signal to the GW device 2 that is the connection destination device. Here, the terminal conditions of the outgoing terminal and the incoming terminal are such that the necessity of header relay is “relay”, and the GW device is a device type in which the necessity of header relay is “relay”. Therefore, the GW device 1 transmits the SIP signal to which the header is added to the GW device 2 (S12).

The GW device 2 determines whether to relay the header of the SIP signal to the respective connection destination devices (GW devices of the other IP networks that are not illustrated and the application server 5). Here, the GW devices are a terminal type in which the necessity of header relay is “relay”, and the application server is a device type in which the necessity of header relay is “not relay”. Therefore, the GW device 2 transmits the SIP signal to which the header is added to the GW devices of the other company networks (S13). On the other hand, the GW device 2 transmits the SIP signal in which the header has been deleted from the SIP signal to the application server 5 (S14).

Furthermore, the GW device 2 receives an SIP signal to which the header is added from the other IP networks (S21). The GW device 2 determines whether to relay the header of the SIP signal to the GW device 1 that is a connection destination device. Here, since the GW device is set to a terminal type in which the necessity of header relay is “relay”, the GW device 2 transmits the SIP signal to which the header is added to the GW device 1 (S22). Note that since the GW device 2 transmits the SIP signal from which the header has been deleted to the application server 5 in S14, the GW device 2 also transmits the SIP signal from which the header has been deleted for the SIP signal returned in S21 (S23).

Upon receiving the SIP signal to which the header is added, the GW device 1 converts the SIP signal into an ISUP signal using ISUP information of the header of said SIP signal, and transmits the ISUP signal to the subscriber system exchanger 3 (S24).

### Second Embodiment

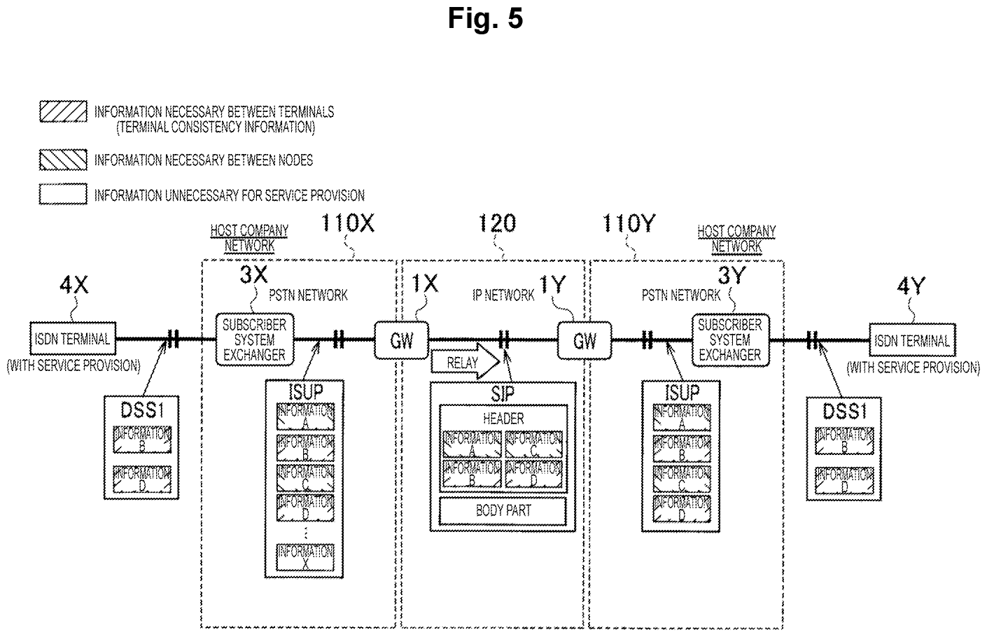

FIG. 5 illustrates a configuration example of networks (networks) of a second embodiment. An example illustrated in FIG. 5 has a network configuration in which an ISUP signal is relayed through a host IP network in a host company network. The host company network includes PSTN networks 110X and 110Y and an IP network 120. Although the two PSTN networks 110X and 110Y are illustrated in FIG. 5 for convenience, the PSTN network 110X and the PSTN network 110Y may be one PSTN network.

In the PSTN networks 110X and 110Y, subscriber system exchangers 3X and 3Y are disposed, respectively. Between the PSTN network 110X and the IP network 120, a GW device 1X is disposed, and between the PSTN network 110Y and the IP network 120, a GW device 1Y is disposed. Since the GW devices 1X and 1Y of the present embodiment are similar to the GW device 1 of the first embodiment, the description thereof will be omitted here.

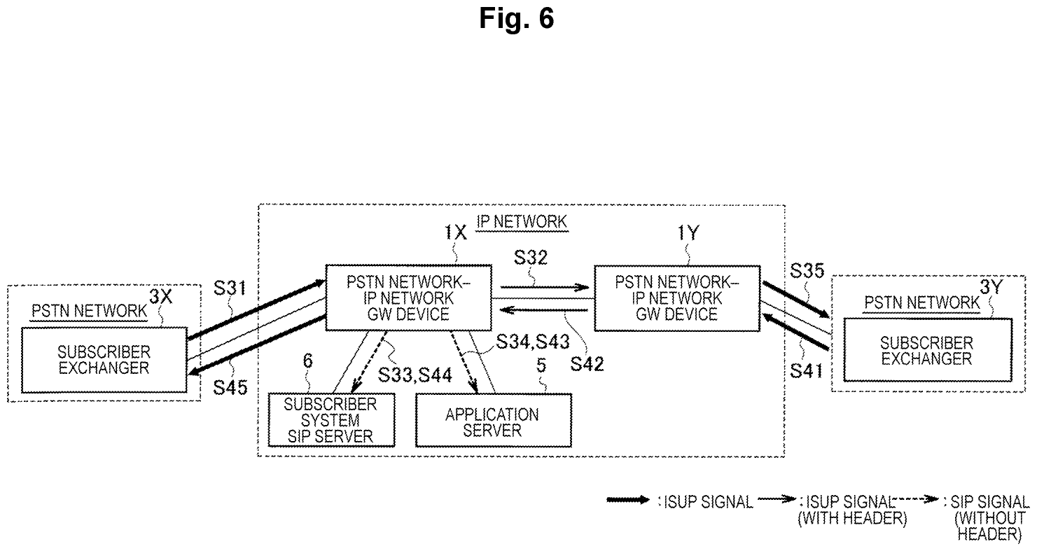

FIG. 6 is a diagram schematically illustrating operation of the GW device 1X and the GW device 1Y (relay system) of the present embodiment.

Upon receiving a DSS1 including terminal consistency information from an accommodated ISDN terminal, the subscriber system exchanger 3X generates an ISUP signal and transmits the ISUP signal to the GW device 1X (S31).

The GW device 1X converts the ISUP signal into an SIP signal in order to relay the ISUP signal in the IP network. Specifically, the GW device 1X extracts information necessary for ISUP service provision from information included in the ISUP signal, and generates an SIP signal in which the extracted information is set in the header. The GW device 1X determines whether to relay the header of the SIP signal for respective connection destination devices.

In the illustrated example, the connection destination devices are the GW device 1Y, an application server 5, and a subscriber system SIP server 6. Here, terminal conditions of an outgoing terminal and an incoming terminal are such that necessity of header relay is “relay”, and the GW device is a terminal type in which the necessity of header relay is “relay”. Therefore, the GW device 1X transmits the SIP signal to which the header is added to the GW device 1Y (S32). On the other hand, the application server and the subscriber system SIP server 6 are a device type in which the necessity of header relay is “not relay”. Therefore, the GW device 1X transmits the SIP signal in which the header has been deleted from the SIP signal to the application server 5 and the subscriber system SIP server 6 (S33 and S34).

The GW device 1Y converts the SIP signal received from the GW device 1X into an ISUP signal and transmits the ISUP signal to the subscriber system exchanger 3Y (S35). Specifically, the GW device 1Y generates the ISUP signal including ISUP information set in the header of the ISUP signal.

Furthermore, the GW device 1Y receives an ISUP signal from the subscriber system exchanger 3Y (S41). Similarly to S31, the GW device 1Y converts the ISUP signal into an SIP signal in order to relay the ISUP signal in the IP network. Then, the GW device 1Y determines whether to relay the header of the SIP signal to the GW device 1X that is a connection destination device. Here, the GW device 1Y relays the SIP signal to which the header is added to the GW device 1X (S42).

The GW device 1X determines whether to relay the header of the SIP signal to the application server and the subscriber system SIP server 6 that are connection destination devices. Since the GW device 1X transmits the SIP signal from which the header has been deleted to the application server 5 and the subscriber system SIP server 6 in S33 and S34, the GW device 1X also transmits an SIP signal from which the header has been deleted for the SIP signal returned in S41 (S43 and S44). Furthermore, similar to S35, the GW device 1X converts the SIP signal received from the GW device 1Y into an ISUP signal and transmits the ISUP signal to the subscriber system exchanger 3X (S45).

### Effects of Embodiment

The above-described GW device 1 of the present embodiment is a GW device 1 that connects a PSTN network to an IP network, and includes a signal conversion unit 11 that extracts information necessary for ISUP service provision from information included in a received ISUP signal, and generates an SIP signal in which the information is set in the header, a determination unit 12 that determines whether to relay the header for a connection destination device on the basis of a type of a connection destination device and terminal conditions of an outgoing terminal and an incoming terminal that are set in the ISUP signal, and a relay unit 13 that relays the SIP signal to a connection destination device in a case of relaying the header, and transmits an SIP signal from which the header has been deleted to a connection destination device in a case of not relaying the header.

As a result, in the present embodiment, information necessary for the ISUP service provision can be distributed to a section in which the ISUP signal is necessary. Specifically, in the present embodiment, a new header can be defined in the SIP signal and only information necessary for the ISUP service provision (terminal consistency information and inter-node information for toll adjustment, and provision of guidance) can be distributed.

Furthermore, in the present embodiment, a distribution range of the header in the IP section can also be determined by condition setting being performed on the basis of address information of the connection destination device and terminal information in the ISUP signal. As a result, only a signal necessary for the ISUP service provision can be distributed, a signal can be distributed only to a relay IP section for the ISUP service provision, an influence range can be minimized, and processing of the SIP signal to which the header in which ISUP information is set is added can be reduced as compared with the SIP-I.

### Hardware Configuration

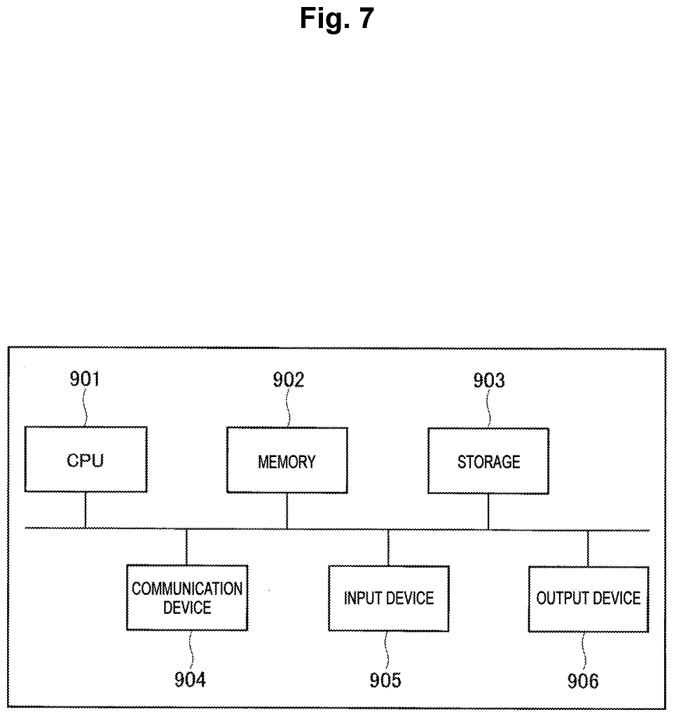

For the above-described GW device 1 and GW device 2, for example, a general-purpose computer system as illustrated in FIG. 7 can be used. The illustrated computer system includes a central processing unit (CPU, processor) 901, a memory 902, a storage 903 (hard disk drive (HDD), solid state drive (SSD)), a communication device 904, an input device 905, and an output device 906. The memory 902 and the storage 903 are storage devices. In the computer system, by the CPU 901 performing a predetermined program loaded on the memory 902, each function of each device is implemented. For example, each function of the GW device 1 and the GW device 2 is implemented by a CPU of the GW device 1 performing a program in a case of a program for the GW device 1 and by a CPU of the GW device 2 performing a program in a case of a program for the GW device 2, respectively.

Furthermore, each of the GW device 1 and GW device 2 may be implemented by one computer, or may be implemented by a plurality of computers. Furthermore, each of the GW device 1 and GW device 2 may be a virtual machine mounted on a computer.

The program for the GW device 1 and the program for the GW device 2 can be stored in a computer-readable recording medium such as an HDD, an SSD, a universal serial bus (USB) memory, a compact disc (CD), or a digital versatile disc (DVD) or can be distributed via a network.

Note that the present invention is not limited to the embodiments and the modification, and various modifications can be made within the scope of the gist of the present invention.

### REFERENCE SIGNS LIST

1, 2 GW device

11 Signal conversion unit

12, 22 Determination unit

13, 23 Relay unit

14, 24 Setting unit

15, 25 Storage unit

16 Terminal condition

17, 27 Connection destination information

3 Subscriber system exchanger

1. A gateway device that connects a public switched telephone network (PSTN) network to an internet protocol (IP) network, the gateway device comprising:
a processor; and
a memory device storing instructions that, when executed by the processor, configure the processor to:
extract information necessary for integrated services digital network user part (ISUP) service provision from information included in a received ISUP signal, and generates a session initiation protocol (SIP) signal in which the information is set in a header;
determine whether to relay the header for a connection destination device on a basis of a type of the connection destination device and terminal conditions of an outgoing terminal and an incoming terminal that are set in the ISUP signal; and
relay the SIP signal to the connection destination device in a case of relaying the header, and transmit an SIP signal from which the header has been deleted to the connection destination device in a case of not relaying the header.

2. A relay system comprising:
a first gateway device according to claim 1; and
a second gateway device that connects a host internet protocol (IP) network to other IP networks, wherein
the second gateway device includes:
a processor; and
a memory device storing instructions that, when executed by the processor, configure the processor to:
determine whether to relay the header of the session initiation protocol (SIP) signal for respective connection destination devices of the second gateway device on a basis of a type of a connection destination device; and
relay the SIP signal to the respective connection destination devices in a case of relaying the header, and transmits an SIP signal from which the header has been deleted to the respective connection destination devices in a case of not relaying the header.

3. A relay method performed by a gateway device that connects a public switched telephone network (PSTN) network to an internet protocol (IP) network, the relay method comprising:
extracting information necessary for integrated services digital network user part (ISUP) service provision from information included in a received ISUP signal, and generating a session initiation protocol (SIP) signal in which the information is set in a header;
determining whether to relay the header for a connection destination device on a basis of a type of the connection destination device and terminal conditions of an outgoing terminal and an incoming terminal that are set in the ISUP signal; and
relaying the SIP signal to the connection destination device in a case of relaying the header, and transmitting an SIP signal from which the header has been deleted to the connection destination device in a case of not relaying the header.

4. A non-transitory computer readable medium storing a program, wherein executing of the program causes a computer to function as the gateway device according to claim 1.
